(19) United States
(12) Patent Application Publication
(10) Pub. No.: US 2025/0343233 A1
(43) Pub. Date: Nov. 6, 2025

(54) SILICON SUBHALIDE-CONTAINING COMPOSITE PARTICLES

(71) Applicant: WACKER CHEMIE AG, Munich (DE)

(72) Inventors: Alena Kalyakina, Munich (DE); Christopher DRAGER, Munich (DE); Jan TILLMAN, Munich (DE)

(73) Assignee: WACKER CHEMIE AG, Munich (DE)

(21) Appl. No.: 18/704,494

(22) PCT Filed: Nov. 16, 2021
(86) PCT No.: PCT/EP2021/081867

§ 371 Date: Apr. 25, 2024

(51) Int. Cl. H01M 4/58; C01B 33/08; H01M 4/36; H01M 4/587; H01M 10/0525

(52) U.S. Cl. CPC H01M 4/582; C01B 33/08; H01M 4/366; H01M 4/587; H01M 10/0525; C01P 2004/61; C01P 2004/62; C01P 2006/12; C01P 2006/14; C01P 2006/16; C01P 2006/40

(57) ABSTRACT

Silicon subhalide-containing composite particles along with processes for producing and uses for the same. Where the silicon subhalide-containing composite particles have a Si content >30% by weight. Wherein the silicon is placed in and on the pores of a porous matrix. The silicon subhalide-containing composite particles include a halogen concentration of 0.0003 to 16% by weight, a pH of 3 to 9, a volume-weighted particle size distribution having diameter percentiles d₅₀ of 0.5 to 20 μm, and a specific BET surface area of at most 170 m²/g.

The present invention relates to silicon subhalide-containing composite particles based on porous particles, silicon and halogen, to processes for producing the composite particles and to the use thereof as active materials in anodes for lithium-ion batteries.

As storage media for electric current, lithium-ion batteries are currently the most practical electrochemical energy storage devices with the highest energy densities. Lithium-ion batteries are mainly used in the field of portable electronics, for tools and also for electrically powered means of transport such as bicycles, scooters or automobiles. Graphitic carbon is currently widely used as the active material for the negative electrode (“anode”) of corresponding batteries. A disadvantage, however, is the relatively low electrochemical capacity of such graphitic carbons, which is theoretically at most 372 mAh per gram of graphite and thus corresponds to only about one tenth of the electrochemical capacity that can theoretically be achieved with lithium metal. Alternative active materials for the anode use an addition of silicon as described for example in EP 3335262 B1. Silicon forms binary electrochemically active alloys with lithium which allow very high electrochemically achievable lithium contents of up to 4200 mAh per gram of silicon.

The incorporation and removal of lithium ions in silicon is associated with the disadvantage that a very high volume change occurs, which can reach up to 300% in the case of complete incorporation. Such changes in volume subject the silicon-containing active material to severe mechanical stress, as a result of which the active material may eventually break apart. This process, also referred to as electrochemical grinding, leads to a loss of electrical contact in the active material and in the electrode structure and thus to the lasting, irreversible loss of the capacity of the electrode.

Furthermore, the surface of the silicon-containing active material reacts with constituents of the electrolyte with continuous formation of passivating protective layers (Solid Electrolyte Interphase; SEI). The components formed are no longer electrochemically active. The lithium bound therein is no longer available to the system, thus leading to a pronounced continuous loss of battery capacity. Due to the extreme change in volume of the silicon during the charging and discharging process of the battery, the SEI regularly ruptures, which exposes further unoccupied surfaces of the silicon-containing active material, which are then exposed to further SEI formation. Since the amount of mobile lithium in the full cell, which corresponds to the usable capacity, is limited by the cathode material, this is increasingly consumed and the capacity of the cell decreases to an unacceptable extent from an application point of view after only a few cycles.

The decrease in capacity over the course of several charging and discharging cycles is also referred to as fading or continuous loss of capacity and is usually irreversible.

A number of silicon-carbon composite particles have been described as silicon-containing active materials for anodes of lithium-ion batteries. Silicon-carbon composite particles are obtained for example from gaseous or liquid silicon precursors by thermal decomposition thereof with deposition of silicon in porous carbon particles. For example, U.S. Pat. No. 10,147,950 B2 describes the deposition of silicon from monosilane SiH4 in porous carbon particles in a tubular furnace or comparable furnace types at elevated temperatures of 300 to 900° C., preferably with agitation of the particles, by a CVD (“chemical vapor deposition”) or PE-CVD (“plasma-enhanced chemical vapor deposition”) process. Even the composites obtainable in this way have cycle stabilities that are insufficient for use in demanding applications. In addition, deposition of the silicon requires high temperatures and/or long reaction times, thus necessitating a extremely great deal of energy and time.

However, the known materials do not claim halogen as a constituent. US2040272592A describes the Si/C composites having a chlorine content up to 1000 ppm for example (determined by X-ray fluorescence, TXRF) and assumes that a higher level of contamination is detrimental to electrochemical performance.

The invention provides silicon subhalide-containing composite particles having
1. a Si content >30% by weight,
2. silicon placed in and on the pores of a porous matrix,
3. a halogen concentration of 0.0003 to 16% by weight,
4. a pH of 3 to 9 and
5. a volume-weighted particle size distribution having diameter percentiles d₅₀ of 0.5 to 20 μm.

As has surprisingly been found, the performance of halogen-containing materials is comparable with that of the halogen-free materials with similar physical characteristics. In addition, halogen-containing materials are producible from the substantially cheaper halogen-containing precursors.

These halogen-containing precursors are simultaneously the industrial precursor to halogen-free SiH₄ which is produced from H₃SiCl, SiH₂Cl₂ or HSiCl₃ and subsequently requires high energy intensive distillative purification. The use of halosilanes can thus significantly reduce the CO₂ footprint of the entire material concept.

Furthermore, it has surprisingly been found that the decomposition temperatures of halogen-containing silanes are substantially lower than hitherto assumed (J. Phys. Chem. 1990, 94, 327-331-above 600° C.) in the presence of reactive surfaces (for example activated carbons).

Production of the silicon subhalide-containing composite particles according to the invention may employ any desired processes. Production by deposition of silicon from gaseous or liquid silicon precursors by infiltration into porous particles analogously to the process described in U.S. Pat. No. 10,147,950 B2 is especially a suitable route to the silicon subhalide-containing composite particles according to the invention.

Deposition of silicon by thermal decomposition from gaseous or liquid silicon precursors in pores and on the surface of the porous particles is in the present case referred to as silicon infiltration.

Identical or different silicon precursors may be reacted with identical or different porous particles.

The invention also provides a process for producing the silicon subhalide-containing composite particles according to the invention by silicon infiltration from silicon precursors selected from halogen-containing silicon precursors that are gaseous and/or liquid at 20° C. and 1013 mbar, wherein at least one halogen-containing silicon precursor is present, in the presence of porous particles having
1. a volume-weighted particle size distribution having diameter percentiles d₅₀ of 0.5 to 20 μm,
2. a total pore volume (Gurvich pore volume) of micropores and mesopores determined by N₂ sorption in the range 0.4-2.2 cm³/g and
3. a PD50 pore diameter determined by N₂ sorption of not more than 30 nm.

Silicon is deposited in the pores and on the surface of the porous particles.

Any desired materials may be employed as the porous particles for the composite particles. Preference is given to the porous carbon particles or the porous oxides, such as silicon dioxide, aluminum oxide, silicon-aluminum mixed oxides, magnesium oxide, lead oxides and zirconium oxide; carbides, such as silicon carbides and boron carbides; nitrides, such as silicon nitrides and boron nitrides; and other ceramic materials such as are describable by the following component formula: AlₐB_{b}C_{c}Mg_{d}NₑO_{f}Si_{g} where 0£a, b, c, d, e, f, g≤1; where at least two coefficients a to g>0 and a*3+b*3+c*4+d*2+g*4³e*3+f*2.

The ceramic materials may be, for example, binary, ternary, quaternary, quinary, senary or septernary compounds. Preference is given to ceramic materials having the following component formulae:
Non-stoichiometric boron nitrides BN_{z} where z=0.2 to 1,
Non-stoichiometric carbon nitrides CN_{z} where z=0.1 to 4/3,
boron carbonitrides BₓCN_{z} where x=0.1 to 20 and z=0.1 to 20, where x*3+4³z*3,
boron nitridooxides BN₂Oᵣ, where z=0.1 to 1 and r=0.1 to 1, where 3³r*2+z*3,
boron carbonitridooxides BₓCN_{z}O, where x=0.1 to 2, z=0.1 to 1 and r=0.1 to 1, where x*3+4³r*2+z*3,
silicon carbooxides SiₓCO_{z} where x=0.1 to 2 and z=0.1 to 2, where x*4+4³z*2,
silicon carbonitrides SiₓCN_{z} where x=0.1 to 3 and z=0.1 to 4, where x*4+4³z*3,
silicon borocarbonitrides Si_{w}BₓCN_{z} where w=0.1 to 3, x=0.1 to 2 and z=0.1 to 4, where w*4+x*3+4³z*3,
silicon borocarbooxides Si_{w}BₓCO_{z} where w=0.10 to 3, x=0.1 to 2 and z=0.1 to 4, where w*4+x*3+4³z*2,
silicon borocarbonitridooxides SiᵥB_{w}CNₓO_{z} where v=0.1 to 3, w=0.1 to 2, x=0.1 to 4 and z=0.1 to 3, where v*4+w*3+4³×*3+z*2 and
aluminum borosilicocarbonitridooxides AlᵤBᵥSiₓCN_{w}O_{z} where u=0.1 to 2.v=0.1 to 2, w=0.1 to 4, x=0.1 to 2 and z=0.1 to 3, where u*3+v*3+x*4+4³w*3+z*2.

Preferred porous particles are based on carbon, silicon dioxide, boron nitride, silicon carbide, silicon nitride or on mixed materials based on these compounds, in particular on silicon dioxide or boron nitride.

Particularly preferred porous particles are porous boron nitride particles, porous silicon oxide particles and/or microporous carbon particles.

Before reaction with the gaseous or liquid silicon precursor the porous particles are preferably dried.

The drying of the porous particles may be carried out at an elevated temperature of 50 to 400° C. in an inert gas atmosphere in any desired reactor suitable for drying. Employable inert gases are for example nitrogen or argon. Drying may alternatively be carried out under an elevated temperature of 50 to 400° C. and reduced pressure of 0.001 to 900 mbar. The drying time is preferably 0.1 seconds to 48 hours. The drying of the porous particles may be carried out in the same reactor as the reaction with the gaseous or liquid silicon precursor or in a separate reactor suitable for drying.

The porous particles preferably have a density, determined by helium pycnometry, of 0.1 to 4 g/cm³ and particularly preferably of 0.3 to 3 g/cm³.

The porous particles have a volume-weighted particle size distribution having diameter percentiles d₅₀ of preferably ≥0.5 m, particularly preferably ≥1.5 μm and most preferably ≥2 μm . The diameter percentiles d₅₀ are preferably ≤20 μm, particularly preferably ≤12 μm and most preferably ≤8 μm .

The volume-weighted particle size distribution of the porous particles is preferably between the diameter percentiles d₁₀≥0.2 μm and d₉₀≤20.0 μm , particularly preferably between d₁₀≥0.4 μm and d₉₀≤15.0 μm and most preferably between d₁₀≥0.6 μm to d₉₀≤12.0 μm .

The porous particles have a volume-weighted particle size distribution with diameter percentiles d₁₀ of preferably ≤10 μm , particularly preferably ≤5 μm , especially preferably ≤3 μm and most preferably ≤2 μm . The diameter percentiles d₁₀ are preferably ≥0.2 μm , particularly preferably ≥0.4 and most preferably ≥0.6 μm .

The porous particles have a volume-weighted particle size distribution having diameter percentiles d₉₀ of preferably >4 μm and particularly preferably ≥8 μm . The diameter percentiles d₉₀ are preferably ≤20 μm , particularly preferably ≤15 and most preferably ≤12 μm .

The volume-weighted particle size distribution of the porous particles has a width d₉₀-d₁₀ of preferably ≤15.0 μm , more preferably ≤12.0 μm , particularly preferably ≤10.0 um, especially preferably ≤8.0 μm and most preferably ≤4.0 μm . The volume-weighted particle size distribution of the porous particles has a width d₉₀-d₁₀ of preferably ≥0.6 μm , particularly preferably ≥0.7 μm and most preferably ≥1.0 μm .

The volume-weighted particle size distribution can be determined according to ISO 13320 using static laser scattering using the Mie model with the Horiba LA 950 measuring device with ethanol as the dispersing medium for the porous particles.

The porous particles can be isolated or agglomerated, for example. The porous particles are preferably non-aggregated and preferably non-agglomerated. Aggregated generally means that in the course of the production of the porous particles, primary particles are initially formed and coalesce and/or primary particles are linked to one another, for example via covalent bonds, and in this way form aggregates. Primary particles are generally isolated particles. Aggregates or isolated particles can form agglomerates. Agglomerates are a loose accumulation of aggregates or primary particles that are linked to one another, for example, via van der Waals interactions or hydrogen bonds. Agglomerated aggregates can easily be split back into aggregates again by common kneading and dispersing processes. Aggregates can be broken down into the primary particles only partially by such processes, if at all. The presence of porous particles in the form of aggregates, agglomerates or isolated particles can be visualized for example using conventional scanning electron microscopy (SEM). By contrast, static light scattering methods for determining the particle size distributions or particle diameters of particles cannot distinguish between aggregates or agglomerates.

The porous particles may have any desired morphology, i.e. for example be splintered, flaky, spherical or else needle-shaped, with splintered or spherical porous particles being preferred.

The morphology may, for example, be characterized by the sphericity w or the sphericity S. According to Wadell's definition, the sphericity w is the ratio of the surface area of a sphere of equal volume to the actual surface area of a body. In the case of a sphere, w has the value 1. According to this definition, the porous particles have a sphericity w of preferably 0.3 to 1.0, particularly preferably of 0.5 to 1.0 and most preferably of 0.65 to 1.0.

The sphericity S is the ratio of the circumference of an equivalent circle with the same area A as the projection of the particle projected onto a surface and the measured circumference U of this projection: S=2πA/U. In the case of an ideally circular particle, S would have the value 1. For the porous particles the sphericity S is in the range of preferably 0.5 to 1.0 and particularly preferably of 0.65 to 1.0 based on the percentiles S₁₀ to S₉₀ of the sphericity number distribution. The measurement of sphericity S is carried out for example using micrographs of individual particles with an optical microscope or in the case of particles <10 μm preferably with a scanning electron microscope by graphical evaluation using image analysis software, such as ImageJ for example.

The porous particles preferably have a gas-accessible pore volume of ≥0.2 cm³/g, particularly preferably ≥0.6 cm³/g and most preferably ≥1.0 cm³/g. This is conducive to obtaining high-capacity lithium-ion batteries. The gas-accessible pore volume is determined by gas sorption measurements with nitrogen according to DIN 66134.

The porous particles are preferably open-pored. Open-pored generally means that pores are connected to the surface of particles, for example via channels, and can preferably exchange mass with the environment, in particular exchange gaseous compounds. This can be demonstrated by gas sorption measurements (analysis according to Brunauer, Emmett and Teller, “BET”), i.e. the specific surface area.

The porous particles have specific surface areas of preferably ≥50 m²/g, particularly preferably ≥500 m²/g and most preferably ≥1000 m²/g. The BET surface area is determined according to DIN 66131 (with nitrogen).

The pores of the porous particles can have any diameter, i.e. generally be in the range of macropores (>50 nm), mesopores (2 to 50 nm) and micropores (<2 nm). The porous particles may be used in any mixtures of different pore types. Preference is given to using porous particles having at most 30% macropores, based on the total pore volume, particularly preferably porous particles without macropores and especially preferably porous particles having at least 50% pores having an average pore diameter of less than 5 nm. The porous particles particularly preferably have exclusively pores having a pore diameter of less than 2 nm (determination method: Pore size distribution according to BJH (gas sorption) to DIN 66134 in the mesopore range and according to Horvath-Kawazoe (gas sorption) to DIN 66135 in the micropore range; the evaluation of the pore size distribution in the macropore range is carried out by mercury porosimetry according to DIN ISO 15901-1). The PD50 pore diameter of the porous particles is preferably in the range 0.5-30 nm, preferably in the range 0.5-20 nm, particularly preferably in the range 0.5-10 nm. The term “PD50 pore diameter” as used here refers to the volume-based average pore diameter based on the total volume of micropores and mesopores (i.e. the pore diameter below which 50% of the total volume of micropores and mesopores are found). Thus according to the invention preferably at least 50% of the total volume of micro- and mesopores are in the form of pores having a diameter of less than 30 nm. For clarification, it is noted that not every macropore volume (pore diameter greater than 50 nm) is taken into account in the determination of the PD50 values. The porous particles have a pH of preferably >3, preferably of >5 and particularly preferably >6. The pH of the porous particles may be determined according to ASTM standard number D1512, method A.

The silicon subhalide composite particles according to the invention are composed of one or more porous particles wherein silicon subhalides have been deposited in pores and on the surface of the porous particles. The deposited subhalides are composed of silicon and halogen, preferably chlorine, having a molar composition SiClₓ in a range x=0.00001-0.15; preferably x=0.00001-0.01; particularly preferably x=0.0001-0.05. In another embodiment the deposited subhalides have a molar composition SiBrₓ and/or SiFₓ and/or SiIₓ in a range x=0.00001-0.15; preferably x=0.00001-0.01; particularly preferably x=0.0001-0.05.

The silicon subchloride composite particles according to the invention have a chlorine content of preferably 0.0003-16% by weight, preferably 0.0003-12% by weight, particularly preferably 0.0003-6% by weight.

The silicon subbromide-composite particles according to the invention have a bromine content of preferably 0.0009-30% by weight, preferably 0.0009-22% by weight, particularly preferably 0.0009-15% by weight.

The silicon subfluoride composite particles according to the invention have a fluorine content of preferably 0.0002-9% by weight, preferably 0.0002-7% by weight, particularly preferably 0.0002-3.5% by weight.

The silicon subiodide composite particles according to the invention have an iodine content of preferably 0.0015-41% by weight, preferably 0.0015-31% by weight, particularly preferably 0.0015-18% by weight.

(Method of determination: X-ray fluorescence analysis, preferably with Bruker AXS S8 Tiger 1 instrument, especially with rhodium anode).

The deposited subhalides may further contain the following elements as constituents: H, O, N, C, S, Fe, Ni, Cu, Mo, W, Mn, Al, K, Na, Ca, Ba, Sr, Cr, Mg, Zn, P.

The silicon subhalide-containing composite particles according to the invention have a volume-weighted particle size distribution having diameter percentiles d₅₀ of preferably ≥1.5 μm and particularly preferably ≥2 μm . The diameter percentiles d₅₀ are preferably ≤13 μm and particularly preferably ≤8 μm .

The volume-weighted particle size distribution of the silicon subhalide-containing composite particles according to the invention is preferably between the diameter percentiles d₁₀≥0.2 μm and d₉₀≤20.0 μm , particularly preferably between d₁₀≥0.4 μm and d₉₀≤15.0 μm and most preferably between d₁₀>0.6 μm to d₉₀≤12.0 μm .

The silicon subhalide-containing composite particles according to the invention have a volume-weighted particle size distribution having diameter percentiles d₁₀ of preferably ≤10 μm , particularly preferably ≤5 μm , especially preferably ≤3 μm and most preferably ≤1 μm . The diameter percentiles d₁₀ are preferably ≥0.2 μm , particularly preferably ≥0.4 μm and most preferably ≥0.6 μm .

The silicon subhalide-containing composite particles according to the invention have a volume-weighted particle size distribution having diameter percentiles d₉₀ of preferably ≥5 μm and particularly preferably ≥10 μm . The diameter percentiles deo are preferably ≤20.0 μm , particularly preferably ≤15.0 μm and most preferably ≤12.0 μm .

The volume-weighted particle size distribution of the silicon subhalide-containing composite particles according to the invention has a width d₉₀-d₁₀ of preferably ≤15.0 um, particularly preferably ≤12.0 μm , more preferably ≤10.0 μm , especially preferably ≤8.0 μm and most preferably ≤4.0 μm . The volume-weighted particle size distribution of the silicon subhalide-containing composite particles according to the invention has a width d₉₀-d₁₀ of preferably ≥0.6 μm , particularly preferably ≥0.7 μm and most preferably ≥1.0 μm .

The silicon subhalide-containing composite particles according to the invention are preferably in the form of particles. The particles may be isolated or agglomerated. The silicon subhalide-containing composite particles according to the invention are preferably non-aggregated and preferably non-agglomerated. The terms isolated, agglomerated and non-aggregated are already defined further above with respect to the porous particles. The presence of silicon subhalide-containing composite particles according to the invention in the form of aggregates or agglomerates can be visualized for example using conventional scanning electron microscopy (SEM).

The silicon subhalide-containing composite particles according to the invention may have any desired morphology, i.e. for example, be splintered, flaky, spherical or else needle-shaped, with splintered or spherical particles being preferred.

According to Wadell's definition, the sphericity Ψ is the ratio of the surface area of a sphere of equal volume to the actual surface area of a body. In the case of a sphere, Ψ has the value 1. According to this definition the silicon subhalide-containing composite particles according to the invention have a sphericity Ψ of preferably 0.3 to 1.0, particularly preferably of 0.5 to 1.0 and most preferably of 0.65 to 1.0.

The sphericity S is the ratio of the circumference of an equivalent circle with the same area A as the projection of the particle projected onto a surface and the measured circumference U of this projection: S=2πA/U. In the case of an ideally circular particle, S would have the value 1. For the silicon subhalide-containing composite particles according to the invention the sphericity S is in the range from preferably 0.5 to 1.0 and particularly preferably from 0.65 to 1.0, based on the percentiles S₁₀ to S₉₀ of the sphericity number distribution. The measurement of sphericity S is carried out for example using micrographs of individual particles with an optical microscope or in the case of particles <10 μm preferably with a scanning electron microscope by graphical evaluation using image analysis software, such as ImageJ for example.

The cycling stability of lithium-ion batteries can be further increased via the morphology, the material composition, in particular the specific surface area or the internal porosity of the silicon subhalide-containing composite particles according to the invention.

The silicon subhalide-containing composite particles according to the invention preferably contain 10 to 90% by weight, more preferably 20 to 80% by weight, particularly preferably 30 to 60% by weight and especially preferably 40 to 50% by weight of silicon obtained via the silicon infiltration based on the total weight of the silicon subhalide-containing composite particles according to the invention (determination preferably by elemental analysis, such as ICP-OES).

The volume of the silicon subhalide introduced in the porous particles is derived from the mass fraction of the silicon subhalide obtained via the infiltration from the silicon precursor based on the total mass of the silicon subhalide-containing composite particles according to the invention divided by the density of silicon (2.336 g/cm³).

The pore volume P of the silicon subhalide-containing particles according to the invention is derived from the sum of gas-accessible and gas-inaccessible pore volume. The Gurvich gas-accessible pore volume of the silicon subhalide-containing composite particles according to the invention is determinable by gas sorption measurements with nitrogen according to DIN 66134.

The gas-inaccessible pore volume of the silicon subhalide-containing composite particles according to the invention is determinable with the formula: Gas-inaccessible pore volume=1/skeletal density−1/pure material density.

The skeletal density is here the density of the composite particles according to the invention determined by helium pycnometry according to DIN 66137-2, the pure material density of the composite particles according to the invention is a theoretical density calculable from the sum of the theoretical pure material densities of the components present in the composite particles according to the invention multiplied by their respective percentage proportions by weight in the overall material. This gives the following for a silicon subhalide-containing composite particle:

Pure material density=theoretical pure material density of silicon (2.336 g/cm³)*proportion of silicon in % by weight+density of porous particles (determined by helium pycnometry)*proportion of porous particles in % by weight.

The pore volume P of the silicon subhalide-containing composite particles according to the invention is in the range from preferably 0 to 400% by volume, more preferably in the range from 100 to 350% by volume and particularly preferably in the range from 200 to 350% by volume based on the volume of the silicon obtained from the silicon infiltration and present in the composite particles according to the invention.

The porosity present in the composite particles according to the invention may be both gas-accessible and gas-inaccessible. The ratio of the volume of gas-accessible to gas-inaccessible porosity of the silicon subhalide-containing composite particles according to the invention may generally be in the range from 0 (no gas-accessible pores) to 1 (all pores are gas-accessible). The ratio of the volume of gas-accessible to gas-inaccessible porosity of the composite particles according to the invention is in the range from 0 to 0.8, particularly preferably in the range from 0 to 0.3 and especially preferably from 0 to 0.1.

The pores of the silicon subhalide-containing composite particles according to the invention may have any desired diameters, for example in the range from macropores (>50 nm), mesopores (2 to 50 nm) and micropores (<2 nm). The composite particles according to the invention may also contain any desired mixtures of different pore types. The composite particles according to the invention preferably contain at most 30% macropores based on the total pore volume, composite particles according to the invention without micropores are particularly preferable and composite particles according to the invention comprising at least 50% pores having an average pore diameter below 5 nm are very particularly preferable. It is especially preferable when the silicon subhalide-containing composite particles according to the invention comprise exclusively pores having a diameter of at most 2 nm.

The silicon subhalide-containing composite particles according to the invention preferably have silicon structures which in at least one dimension have structure sizes of preferably at most 1000 nm, more preferably less than 100 nm, particularly preferably less than 5 nm (determination method: scanning electron microscopy (SEM) and/or high resolution transmission electron microscopy (HR-TEM)).

It is preferable when the silicon subhalide-containing composite particles according to the invention contain silicon or silicon subhalides in the form of layers in pores and/or on the outer surface having a layer thickness of at most 1000 nm, more preferably less than 100 nm, particularly preferably less than 5 nm (determination method: scanning electron microscopy (SEM) and/or high resolution transmission electron microscopy (HR-TEM)). The composite particles according to the invention may also contain silicon or silicon subhalides in the form of layers formed from silicon particles. Silicon particles have a diameter of preferably at most 1000 nm, more preferably less than 100 nm, particularly preferably less than 10 nm (determination method: scanning electron microscopy (SEM) and/or high resolution transmission electron microscopy (HR-TEM)). The data about the silicon particles preferably relates here to the diameter of the circumference of the particles in the microscope image.

The silicon subhalide-containing composite particles according to the invention have a specific surface area of at most 170 m²/g, preferably less than 100 m²/g, yet more preferably less than 60 m²/g and especially preferably less than 20 m²/g. The BET surface area is determined according to DIN 66131 (with nitrogen). Using the silicon subhalide-containing composite particles according to the invention as active material in anodes for lithium-ion batteries thus makes it possible to reduce the SEI formation and enhance the initial coulomb efficiency.

Furthermore, the silicon deposited from the silicon precursor in the silicon-containing material may comprise dopants, for example selected from the group comprising Fe, Al, Cu, S, CI, Zr, Ti, Pt, Ni, Cr, Sn, Ag, Co, Zn, B, P, Sb, Pb, Ge, Bi, rare earths or combinations thereof. Li and/or Sn are preferred. The content of dopants in the silicon subhalide-containing composite particles is preferably at most 1% by weight and particularly preferably at most 100 ppm based on the total weight of the composite particles determinable by ICP-OES.

The silicon subhalide-containing composite particles according to the invention generally have a surprisingly high stability under compressive load and/or shear load. The compressive load stability and the shear stability of the composite particles according to the invention is demonstrated for example by the fact that the composite particles according to the invention show only slight changes, if any, in their porous structure in SEM under compressive stress (for example during electrode compaction) or shear stress (for example during electrode preparation).

The production of the silicon subhalide-containing composite particles according to the invention may be carried out in any desired reactors commonly used for silicon infiltration. Preference is given to reactors selected from fluidized bed reactors, rotary kilns, which may be oriented in any desired arrangement from horizontal to vertical, and fixed-bed reactors, which may be operated as open or closed systems, for example as pressure reactors. Particular preference is given to reactors which allow homogeneous commixing of the porous particles and the silicon-containing material formed during infiltration with the silicon precursors. This is advantageous for the most homogeneous possible deposition of silicon in pores and on the surface of the porous particles. Most preferred reactors are fluidized bed reactors, rotary kilns or pressure reactors, especially fluidized bed reactors or pressure reactors.

Silicon is generally deposited from the halogen-containing silicon precursors by thermal decomposition. The silicon infiltration may employ one silicon precursor or two or more silicon precursors in admixture or alternately, wherein at least one chlorine-containing precursor must be employed. Preferred halogen-containing silicon precursors are selected from trichlorosilane HSiCl₃, trifluorosilane HSiF₃, tribromosilane HSiBr₃, triiodosilane HSiI₃, dichlorosilane H₂SiCl₂, difluorosilane H₂SiF₂, dibromosilane H₂SiBr₂, diiodosilane H₂SiI₂, monochlorosilane H₃SiCl, monofluorosilane H₃SiF, monobromosilane H₃SiBr, monoiodosilane H₃SiI, tetrachlorosilane SiCl₄, tetrafluorosilane SiF₄, tetrabromosilane SiBr₄, tetraiodosilane SiI₄, hexachlorodisilane Si₂Cl₆, hexafluorodisilane Si₂F₆, hexabromodisilane Si₂Br₆, hexaiododisilane Si₂I₆ and higher linear, branched or else cyclic homologs such as for example 1,1,2,2-tetrachlorodisilane Cl₂HSi—SiHCl₂; halogenated and partially halogenated oligo- and polysilanes, methylchlorosilanes, such as trichloromethylsilane MeSiCl₃, dichlorodimethylsilane Me₂SiCl₂, chlorotrimethylsilane MesSiCl, tetramethylsilane Me₄Si, dichloromethylsilane MeHSiCl₂, chloromethylsilane MeH₂SiCl. Halogen-free silicon precursors in the mixtures are selected from silicon-hydrogen compounds, such as monosilane SiH₄, disilane Si₂H₆ and higher linear, branched or else cyclic homologs, neopentasilane Si₅H₁₂, cyclopentasilane, cyclohexasilane Si₆H₁₂, methylsilanes such as methylsilane MeH₃Si, chlorodimethylsilane Me₂HSiCl, dimethylsilane Me₂H₂Si, trimethylsilane MesSiH or else mixtures of the described silicon compounds. In particular silicon precursors are selected from trichlorosilane HSiCl₃, dichlorosilane H₂SiCl₂, monochlorosilane H₃SiCl, tetrachlorosilane SiCl₄, hexachlorodisilane Si₂Cl₆ and/or mixtures thereof with H-containing silanes, such as monosilane SiH₄ or disilane Si₂H₆. Particular preference is given to dichlorosilane H₂SiCl₂, monochlorosilane H₃SiCl and monosilane SiH₄ with a proportion of more than 5 ppm of chlorosilane SiHₙCl₄₋ₙ (n=0-3).

Reactive components free from silicon may also be present in admixture or alternately with silicon precursors. Further reactive constituents that may be present in the silicon-free reactive component comprise hydrogen or else hydrocarbons selected from the group containing aliphatic hydrocarbons having 1 to 10 carbon atoms, preferably 1 to 6 carbon atoms, for example methane, ethane, propane, butane, pentane, isobutane, hexane, cyclopropane, cyclobutane, cyclopentane, cyclohexane, cycloheptane; unsaturated hydrocarbons having 1 to 10 carbon atoms such as ethene, acetylene, propene or butene, isoprene, butadiene, divinylbenzene, vinylacetylene, cyclohexadiene, cyclooctadiene, cyclic unsaturated hydrocarbons, for example cyclopropene, cyclobutene, cyclopentene, cyclohexene, cyclohexadiene, cyclopentadiene, dicyclopentadiene or norbornadiene, aromatic hydrocarbons, for example benzene, toluene, p-, m-, o-xylene, styrene (vinylbenzene), ethylbenzene, diphenylmethane or naphthalene, further aromatic hydrocarbons, for example phenol, o-, m-, p-cresol, cymene, nitrobenzene, chlorobenzene, pyridine, anthracene or phenanthrene, myrcene, geraniol, thioterpineol, norbornane, borneol, isoborneol, bornane, camphor, limonene, terpinene, pinene, pinane, carene, phenol, aniline, anisole, furan, furfural, furfuryl alcohol, hydroxymethylfurfural, bishydroxymethylfuran and mixed fractions comprising a multiplicity of such compounds, for example from natural gas condensates, petroleum distillates or coke oven condensates, mixed fractions from the product streams of a fluid catalytic cracker (FCC), steam cracker or a Fischer-Tropsch synthesis plant, or more generally hydrocarbon-containing material streams from wood, natural gas, petroleum and coal processing.

These silicon-free reactive components may also be introduced into the gas space of the reactor alternately with the silicon precursors.

In a special embodiment of the process the monosilane or mixtures of silanes such as for example mixtures of monosilane SiH₄, trichlorosilane HSiCl₃, dichlorosilane H₂SiCl₂, monochlorosilane H₃SiCl and tetrachlorosilane SiCl₄, wherein each constituent may be present from 0 to 99.9% by weight, is produced by a suitable process only immediately before use in the reactor. These processes generally proceed from trichlorosilane HSiCl₃ which is rearranged into the other components of the described mixture over a suitable catalyst (e.g. AmberLyst™ A21DRY). The composition of the resulting mixture is determined primarily by the workup of the mixture formed, after one or more rearrangement stages, at one or more different temperatures.

Particularly preferred reactive components are selected from the group comprising monosilane SiH₄, oligomeric or polymeric silanes, in particular linear silanes of general formula SiₙHₙ₊₂, wherein n may comprise an integer in the range 2 to 10, and cyclic silanes of general formula —[SiH₂]ₙ—, wherein n may comprise an integer in the range 3 to 10, trichlorosilane HSiCl₃, dichlorosilane H₂SiCl₂ and monochlorosilane H₃SiCl, wherein these may be employed alone or else as mixtures, very particular preference is given to the use of SiH₄, HSiCl₃ and H2SiCl₂ alone or in admixture.

Furthermore, the reactive components may additionally also contain further reactive constituents, such as dopants based on compounds containing boron, nitrogen, phosphorus, arsenic, germanium, iron or else nickel, for example. The dopants are preferably selected from the group comprising ammonia NH₃, diborane B₂H₆, phosphane PH₃, germane GeH₄, arsane AsH₃, iron pentacarbonyl Fe(CO)₄ and nickel tetracarbonyl Ni(CO)₄.

The composition of the gas phase may be determined for example via a gas chromatograph and/or thermal conductivity detector and/or an infrared spectrometer and/or a Raman spectrometer and/or a mass spectrometer, thus allowing targeted control of the deposition process. In a preferred embodiment the hydrogen content is determined using a thermal conductivity detector and/or any chlorosilanes present are determined using a gas chromatograph or gas infrared spectrometer.

The silicon subhalide-containing composite particles may also be aftertreated and/or deactivated. The composite particles are preferably purged with oxygen, in particular with a mixture of inert gas and oxygen, in the same or another reactor. This makes it possible for example to modify and/or deactivate the surface of the silicon and the silicon subhalide. For example it is possible to effect a reaction of any reactive groups present on the surface of the silicon and the silicon subhalide. It is preferable to employ to this end a mixture of nitrogen, oxygen and optionally alcohols and/or water which preferably contains at most 20% by volume, particularly preferably at most 10% by volume and especially preferably at most 5% by volume of oxygen and preferably at most 100% by volume, particularly preferably at most 10% by volume and especially preferably at most 1% by volume of water. This step is preferably carried out at temperatures of at most 200° C., particularly preferably at most 100° C. and especially preferably at most 50° C. The deactivation of the particle surfaces may also be effected with a gas mixture containing inert gas and alcohols. It is preferable to employ nitrogen and isopropanol here. However, it is also possible to employ methanol, ethanol, butanols, pentanols or longer-chain and branched alcohols and diols.

The deactivation of the composite particles may also be effected by dispersion in a liquid solvent or a solvent mixture. This may contain isopropanol or an aqueous solution for example.

The deactivation of the composite particles may also be selectively carried out by a coating using C-, Al- and B-containing precursors at temperatures of 200-800° C. and optionally subsequent treatment with an oxygen-containing atmosphere.

The aftertreatment of composite particles could alternatively be carried out with water or aqueous solutions. The particles are preferably washed several times with water until the pH of the washing water is >3. The samples could be treated with ultrasound for example.

The process for producing the composite articles according to the invention is preferably performed in an inert gas atmosphere, for example in a nitrogen or argon atmosphere.

In the process the silicon infiltration is preferably carried out at 280 to 900° C., particularly preferably at 320 to 600° C., in particular at 350 to 450° C.

The silicon infiltration may be carried out at reduced pressure, normal pressure or elevated pressure. It is preferable when the infiltration is carried out at normal pressure or elevated pressure up to 50 bar.

In all other respects the process may be carried out in a conventional manner such as is common for the infiltration of silicon from silicon precursors, if necessary with routine adaptations customary to those skilled in the art.

The invention further provides an anode material for a lithium-ion battery which contains the silicon subhalide-containing composite particles according to the invention.

The anode material is preferably based on a mixture comprising the silicon subhalide-containing composite particles according to the invention, one or more binders, optionally graphite as further active material, optionally one or more further electrically conducting components and optionally one or more additives.

The anode material contains the silicon subhalide-containing composite particles according to the invention, preferably one or more binders, optionally graphite as further active material, optionally one or more further electrically conducting components and optionally one or more additives.

By using other electrically conducting components in the anode material, the contact resistances within the electrode and between the electrode and current collector can be reduced, which improves the current-carrying capacity of the lithium-ion battery. Preferred further electrically conducting components are conductive carbon black, carbon nanotubes or metallic particles, for example copper.

The primary particles of conductive carbon black preferably have a volume-weighted particle size distribution between the diameter percentiles d₁₀=5 nm and d₉₀=200 nm. The primary particles of conductive carbon black can also be branched like a chain and form structures up to um in size. Carbon nanotubes preferably have diameters of 0.4 to 200 nm, more preferably 2 to 100 nm and most preferably 5 to 30 nm. The metallic particles have a volume-weighted particle size distribution between the diameter percentiles d₁₀=5 nm and d₉₀=800 nm.

The anode material preferably comprises 0 to 95% by weight, particularly preferably 0 to 40% by weight and most preferably 0 to 25% by weight of one or more further electrically conducting components based on the total weight of the anode material.

The silicon subhalide-containing composite particles according to the invention may be present in the anodes for lithium-ion batteries at preferably 5 to 100% by weight, particularly preferably 30 to 100% by weight and most preferably 60 to 100% by weight based on the total active material present in the anode material.

Preferred binders are polyacrylic acid or alkali metal salts thereof, especially lithium or sodium salts, polyvinyl alcohols, cellulose or cellulose derivatives, polyvinylidene fluoride, polytetrafluoroethylene, polyolefins, polyimides, especially polyamide-imides, or thermoplastic elastomers, especially ethylene-propylene-diene terpolymers. Particular preference is given to polyacrylic acid, polymethacrylic acid or cellulose derivatives, especially carboxymethyl cellulose. The alkali metal salts, in particular lithium or sodium salts, of the aforementioned binders are also particularly preferred. Most preferred are the alkali metal salts, especially lithium or sodium salts, of polyacrylic acid or polymethacrylic acid. All or preferably a proportion of the acid groups of a binder may be present in the form of salts. The binders have a molar mass of preferably 100 000 to 1 000 000 g/mol. Mixtures of two or more binders can also be used.

The graphite used can generally be natural or synthetic graphite. The graphite particles preferably have a volume-weighted particle size distribution between the diameter percentiles d₁₀>0.2 μm and d₉₀<200 μm .

Examples of additives are pore formers, dispersants, leveling agents or dopants, for example elemental lithium.

Preferred formulations for the anode material preferably contain 5 to 95% by weight, in particular 60 to 90% by weight, of the silicon subhalide-containing composite particles according to the invention; 0 to 90% by weight, in particular 0 to 40% by weight, of further electrically conductive components; 0 to 90% by weight, in particular 5 to 40% by weight, of graphite; 0 to 25% by weight, in particular 5 to 20% by weight, of binders; and optionally 0 to 80% by weight, in particular 0.1 to 5% by weight, of further additives, wherein the amounts in % by weight are based on the total weight of the anode material and the proportions of all constituents of the anode material sum to 100% by weight.

The invention further relates to an anode comprising a current collector coated with the anode material according to the invention. The anode is preferably used in lithium-ion batteries.

The constituents of the anode material can be processed into an anode ink or paste, for example, in a solvent, preferably selected from the group comprising water, hexane, toluene, tetrahydrofuran, N-methylpyrrolidone, N-ethylpyrrolidone, acetone, ethyl acetate, dimethyl sulfoxide, dimethylacetamide and ethanol and mixtures of these solvents, preferably using rotor-stator machines, high-energy mills, planetary kneaders, agitator bead mills, vibrating plates or ultrasonic devices.

The anode ink or paste has a pH of preferably 2 to 10 (determined at 20° C., for example with the WTW pH 340i PH meter with SenTix RJD probe).

For example, the anode ink or paste can be knife-coated onto a copper foil or another current collector. Other coating methods may also be used in accordance with the invention, such as spin coating, roller, dip or slot coating, brushing or spraying.

Before the copper foil is coated with the anode material according to the invention, the copper foil may be treated with a commercially available primer for example based on polymer resins or silanes. Primers can lead to an improvement in adhesion to the copper, but themselves generally have practically no electrochemical activity.

The anode material is preferably dried to constant weight. The drying temperature depends on the components used and the solvent used. The drying temperature is preferably between 20° C. and 300° C., particularly preferably between 50° C. and 150° C.

The layer thickness, i.e. the dry layer thickness of the anode coating, is preferably 2 μm to 500 μm , particularly preferably 10 μm to 300 μm .

Finally, the electrode coatings may be calendered to achieve a defined porosity. The electrodes produced in this way preferably have porosities of 15 to 85%, which may be determined by mercury porosimetry according to DIN ISO 15901-1. Preferably, 25 to 85% of the pore volume that can be determined in this way is provided by pores that have a pore diameter of 0.01 to 2 μm .

The invention further provides a lithium-ion battery comprising at least one anode containing the silicon subhalide-containing composite particles according to the invention. The lithium-ion battery may further contain a cathode, two electrically conducting connections to the electrodes, a separator and an electrolyte with which the separator and the two electrodes are impregnated and also a housing accommodating said parts.

In the context of this invention, the term lithium-ion battery also includes cells. Cells generally comprise a cathode, an anode, a separator and an electrolyte. In addition to one or more cells lithium-ion batteries preferably also contain a battery management system. Battery management systems are generally used to control batteries, for example using electronic circuits, in particular for detecting the state of charge, for deep discharge protection or overcharge protection.

Preferred cathode materials used may be lithium cobalt oxide, lithium nickel oxide, lithium nickel cobalt oxide (doped or undoped), lithium manganese oxide (spinel), lithium nickel cobalt manganese oxides, lithium nickel manganese oxides, lithium iron phosphate, lithium cobalt phosphate, lithium manganese phosphate, lithium vanadium phosphate or lithium vanadium oxides.

The separator is preferably an electrically insulating membrane permeable to ions, preferably composed of polyolefins, for example polyethylene (PE) or polypropylene (PP), or polyester or corresponding laminates. The separator can alternatively consist of or be coated with glass or ceramic materials, as is common in battery manufacturing. As is known, the separator separates the first electrode from the second electrode and thus prevents electronically conducting connections between the electrodes (short circuit).

The electrolyte is preferably a solution comprising one or more lithium salts (=conducting salt) in an aprotic solvent. Conducting salts are preferably selected from the group comprising lithium hexafluorophosphate, lithium hexafluoroarsenate, lithium perchlorate, lithium tetrafluoroborate, lithium imides, lithium methides, LiCF₃SO₃, LiN(CF₃SO₂) and lithium borates. The concentration of the conducting salt, based on the solvent, is preferably between 0.5 mol/l and the solubility limit of the relevant salt. It is particularly preferably from 0.8 to 1.2 mol/l.

Examples of solvents that can be used are cyclic carbonates, propylene carbonate, ethylene carbonate, fluoroethylene carbonate, dimethyl carbonate, diethyl carbonate, ethyl methyl carbonate, dimethoxyethane, diethoxyethane, tetrahydrofuran, 2-methyltetrahydrofuran, gamma-butyrolactone, dioxolane, acetonitrile, organic carbonic acid esters or nitriles, individually or as mixtures thereof.

The electrolyte preferably contains a film former, such as vinylene carbonate or fluoroethylene carbonate. As a result, a significant improvement in the cycle stability of the anodes containing the silicon-containing material according to the invention can be achieved. This is mainly attributed to the formation of a solid electrolyte interphase on the surface of active particles. The proportion of the film former in the electrolyte is preferably between 0.1 and 20.0% by weight, particularly preferably between 0.2 and 15.0% by weight and most preferably between 0.5 and 10% by weight.

In order to match the actual capacities of the electrodes of a lithium-ion cell as optimally as possible, it is advantageous to balance the materials for the positive and negative electrodes in terms of quantity. In this context, it is of particular importance that during the first or initial charge/discharge cycle of secondary lithium-ion cells (so-called formation), a covering layer forms on the surface of the electrochemically active materials in the anode. This top layer is referred to as “Solid Electrolyte Interphase” (SEI) and generally consists primarily of electrolyte decomposition products and a certain amount of lithium, which is accordingly no longer available for further charge/discharge reactions. The thickness and composition of the SEI depends on the type and the quality of the anode material used and the electrolyte solution used.

In the case of graphite, the SEI is particularly thin. On graphite, there is a loss of typically 5% to 35% of the mobile lithium in the cell in the first charging step. Accordingly, the reversible capacity of the battery also decreases.

In the case of anodes with the silicon subhalide-containing composite particles according to the invention, there is a loss of mobile lithium in the first charging step of preferably at most 30%, particularly preferably at most 20% and most preferably at most 10%, which is significantly below the values of the prior art described, for example in U.S. Pat. No. 10,147,950 B1, for silicon-containing composite anode materials.

The lithium-ion battery according to the invention can be produced in all of the usual forms, for example in wound, folded or stacked form.

All substances and materials used to produce the lithium-ion battery according to the invention, as described above, with the exception of the composite particles according to the invention are known. The production of the parts of the battery according to the invention and the assembly thereof to afford the battery according to the invention is carried out by the processes known in the field of battery production.

The silicon subhalide-containing composite particles according to the invention feature very good electrochemical behavior and result in lithium-ion batteries with high volumetric capacities and excellent performance characteristics. The composite particles according to the invention are permeable to lithium ions and electrons and thus allow charge transport. The amount of SEI in lithium-ion batteries can be reduced to a large extent with the silicon subhalide-containing composite particles according to the invention. In addition, due to the design of the composite particles according to the invention, the SEI no longer detaches from the surface of the composite particles according to the invention or at least detaches therefrom to a much lesser extent. All this results in high cycle stability of corresponding lithium-ion batteries. The fading and trapping can be minimized. Furthermore lithium-ion batteries according to the invention show a low initial and continuous loss of lithium available in the cell and thus high Coulomb efficiencies.

In the examples that follow, unless otherwise stated in each case, all amounts and percentages are based on weight, all pressures are 0.10 MPa (abs.) and all temperatures are 20° C.

### EXAMPLES

pH is determined according to ASTM Standard number D1512, Method A.

### Scanning Electron Microscopy (SEM/EDX):

The microscope analyses were carried out using a Zeiss Ultra 55 scanning electron microscope and an energy-dispersive Oxford X-Max 80N x-ray spectrometer. Before analysis, the samples underwent vapor deposition of carbon, using a Safematic Compact Coating Unit 010/HV, to prevent charging phenomena. Cross sections of the silicon-containing materials were produced with a Leica TIC 3X ion cutter at 6 kV.

### Inorganic/Elemental Analysis:

The C contents were determined using a Leco CS 230 analyzer and a Leco TCH-600 analyzer was used to determine oxygen and nitrogen contents. The qualitative and quantitative determination of other elements, especially the determination of the alkali or alkaline earth metals, was carried out by ICP (inductively coupled plasma) emission spectrometry (Optima 7300 DV, Perkin Elmer). To this end the samples were subjected to acid digestion (HF/HNO₃) in a microwave (Microwave 3000, Anton Paar). The ICP-OES determination is guided by ISO 11885 “Water quality-Determination of selected elements by inductively coupled plasma optical emission spectrometry (ICP-OES) (ISO 11885:2007); German version EN ISO 11885:2009”, which is used for analysis of acidic aqueous solutions (for example acidified drinking water, wastewater and other water samples, aqua regia extracts of soils and sediments).

### X-ray Fluorescence Analysis:

The chlorine content was determined by X-ray fluorescence analysis on a Bruker AXS SB Tiger 1 with a rhodium anode.

To this end, 5.00 g of the sample were mixed with 1.00 g of Boreox and 2 droplets of ethanol and pressed into tablets in an HP 40 tablet press from Herzog for 15 seconds at a pressure of 150 kN.

### Particle Size Determination:

The particle size distribution was determined in accordance with ISO 13320 by static laser scattering using a Horiba LA 950. In the preparation of the samples particular care must be taken when dispersing the particles in the measurement solution to ensure it is not the size of agglomerates that is measured, but of the individual particles. For the materials examined here, these were dispersed in ethanol. To this end, the dispersion was treated with 250 W ultrasound in a Hielscher UIS250v ultrasound laboratory instrument with LS24d5 sonotrode for 4 minutes prior to measurement if required.

### BET Surface Area Measurement:

The specific surface area of the materials was measured by gas sorption with nitrogen using a Sorptomatic 199090 instrument (Porotec) or BELSorp MAX II instrument (Microtrac) or SA-9603MP instrument (Horiba) by the BET method (determination according to DIN ISO 9277:2003-05 using nitrogen).

### Skeletal Density:

The skeletal density, i.e, the density of the porous solid based on the volume of only the pore spaces accessible to gas from the outside, was determined by helium pycnometry in accordance with DIN 66137-2.

### Gas-Accessible Pore Volume (Gurvich Pore Volume):

Gurvich gas-accessible pore volume was determined by gas sorption measurements with nitrogen according to DIN 66134.

### PD50 Pore Diameter:

The PD50 pore diameter was calculated as a volumetric average pore diameter, based on the total volume of the micropores defined by the Horvath-Kawazoe method according to DIN 66135 and mesopores defined by the BJH method according to DIN 66134.

The following examples 1-6 and comparative example 1 describe the production and properties of the porous carbon particles used for the production of the silicon-carbon according to the invention.

### Production of Silicon Composite Particles

### Comparative Example 1A (Noninventive): Silicon-Carbon Composite Particles From Porous Carbon Particles

An electrically heated autoclave consisting of a cylindrical lower part (cup) and a lid with a plurality of connections (for example for the gas inflow, gas outflow, temperature and pressure measurement) having a volume of 5.3 L was used for the reaction. The stirrer employed was a virtually close-clearance helical stirrer. This had a height corresponding to about 50% of the clearance height of the reactor interior. The helical stirrer had a design such that it allowed temperature measurement directly in the bed. The autoclave was charged with 342.5 g of the porous carbon (spec. surface area=1617 m²/g, Gurvich pore volume=0.80 cm³/g) and sealed. The autoclave was initially evacuated. It was subsequently pressurized to a pressure of 16.0 bar with SiH₄ (70 g) at 350° C. The autoclave was then heated to a temperature of 420° C. within 20 minutes and the temperature was maintained for 60 minutes. The pressure was then reduced to 1.5 bar and the autoclave was pressurized to a pressure of 16.0 bar with SiH₄ (59 g) at a temperature of 370° C. The autoclave was then heated to a temperature of 420° C. within 20 minutes and the temperature was maintained for 60 minutes. The pressure was then reduced to 1.5 bar and the autoclave was pressurized to a pressure of 16.0 bar with SiH₄ (57 g) at a temperature of 370° C. The autoclave was then heated to a temperature of 420° C. within 20 minutes and the temperature was maintained for 60 minutes. The pressure was then reduced to 1.5 bar and the autoclave was pressurized to a pressure of 16.0 bar with SiH₄ (55 g) at a temperature of 370° C. The autoclave was then heated to a temperature of 420° C. within 20 minutes and the temperature was maintained for 60 minutes. The pressure was then reduced to 1.5 bar and the autoclave was pressurized to a pressure of 16.0 bar with SiH₄ (54 g) at a temperature of 370° C. The autoclave was then heated to a temperature of 420° C. within 20 minutes and the temperature was maintained for 60 minutes. The pressure was then reduced to 1.5 bar and the autoclave was pressurized to a pressure of 16.0 bar with SiH₄ (52 g) at a temperature of 370° C. The autoclave was then heated to a temperature of 420° C. within 20 minutes and the temperature was maintained for 60 minutes. The pressure was then reduced to 1.5 bar and the autoclave was pressurized to a pressure of 16.0 bar with SiH₄ (51 g) at a temperature of 370° C. The autoclave was then heated to a temperature of 420° C. within 20 minutes and the temperature was maintained for 60 minutes. The pressure was then reduced to 1.5 bar and the autoclave was pressurized to a pressure of 10.0 bar with SiH₄ (29 g) at a temperature of 370° C. The autoclave was then heated to a temperature of 420° C. within 20 minutes and the temperature was maintained for 60 minutes. The autoclave was then cooled to a temperature of 100° C. before purging five times with nitrogen, five times with lean air having an oxygen content of 5%, five times with lean air having an oxygen content of 10% and then five times with air.

The pressure in the autoclave was reduced to 1 bar before purging three times with nitrogen. An amount of 651 g of silicon-carbon composite particles in the form of a black, fine solid were isolated under an Ar atmosphere.

### Comparative example 1B (Noninventive): Silicon-Subchloride-Containing Composite Particles From Porous Carbon Particles

A tubular reactor was charged with 3.0 g of the porous carbon particles (spec. surface area=2140 m²/g, Gurvich pore volume=1.01 cm³/g, pH=5.4) in a quartz glass boat. After inertization with nitrogen, the reactor was heated to 450° C. Upon reaching the reaction temperature the reactive gas (mixture of 20 g/h of trichlorosilane (liquid) and 10 NL/h of Ar) was passed through the reactor for 24 h. The reactor was then purged with inert gas and cooled to room temperature and the product was withdrawn.

### Example 1: Silicon-Subchloride-Containing Composite Particles from Porous Carbon Particles

A tubular reactor was charged with 3.0 g of the porous carbon particles (spec. surface area=2140 m²/g, Gurvich pore volume=1.01 cm³/g, pH=5.4) in a quartz glass boat. After inertization with nitrogen, the reactor was heated to 450° C. Upon reaching the reaction temperature the reactive gas (mixture of 20 g/h of trichlorosilane (liquid) and 10 NL/h of Ar) was passed through the reactor for 24 h. The reactor was then purged with inert gas and cooled to room temperature and the product was withdrawn. The product was then suspended in the water at 20° C. (30 ml water/1 g product), stirred for 10 minutes and filtered off in a Buchner funnel while measuring the pH. The whole procedure was repeated until the pH of the washing water was >3 (generally 3-5 times).

### Example 2: Silicon-Carbon Composite Particles From Porous Carbon Particles

A tubular reactor was charged with 3.0 g of the porous carbon particles (spec. surface area=2140 m²/g, Gurvich pore volume=1.01 cm³/g, pH=5.4) in a quartz glass boat. After inertization with nitrogen, the reactor was heated to 415° C. Upon attaining the reaction temperature the reactive gas (mixture of 5 NL/h of dichlorosilane and 10 NL/h of Ar) was passed through the reactor for 15 h. The reactor was then purged with inert gas and cooled to room temperature and the product was withdrawn. The product was then suspended in water at 20° C. (30 ml water/1 g product), treated for 1 h in an ultrasonic bath at 80° C. and filtered off in a Buchner funnel while measuring the pH. The whole procedure was repeated until the pH of the washing water was >3.

### Example 3: Silicon-Carbon Composite Particles From Porous Carbon Particles

A tubular reactor was charged with 3.0 g of the porous carbon particles (spec. surface area=2140 m²/g, Gurvich pore volume=1.01 cm³/g, pH=5.4) in a quartz glass boat. After inertization with nitrogen, the reactor was heated to 380° C. Upon attaining the reaction temperature the reactive gas 1 (mixture of 33 g/h of trichlorosilane (liquid) and 10 NL/h of Ar) was passed through the reactor for 8 h. Subsequently, the reactive gas 2 (10% SiH₄ in N₂, 10 NL/h) was passed through the reactor for 9 h. The reactor was then purged with inert gas and cooled to 20° C. and the product was withdrawn.

### Example 4: Silicon-Carbon Composite Particles From Porous Carbon Particles

A tubular reactor was charged with 3.0 g of the porous carbon particles (spec. surface area=2140 m²/g, Gurvich pore volume=1.01 cm³/g, pH=5.4) in a quartz glass boat. After inertization with nitrogen, the reactor was heated to 380° C. Upon attaining the reaction temperature the reactive gas 1 (mixture of 5 NL/h of dichlorosilane and 10 NL/h of Ar) was passed through the reactor for 15 h. The reactor was then heated to 400° C. Upon attaining the reaction temperature the reactive gas 2 (10% SiH₄ in N₂, 10 NL/h) was passed through the reactor for 7.6 h. The reactor was then purged with inert gas and cooled to room temperature and the product was withdrawn.

### Example 5: Silicon-Carbon Composite Particles From Porous Carbon Particles by Reaction in a Pressure Reactor

An electrically heated autoclave consisting of a cylindrical lower part (cup) and a lid with a plurality of connections (for example for the gas inflow, gas outflow, temperature and pressure measurement) having a volume of 594 ml was used for the reaction. The stirrer employed was a virtually close-clearance helical stirrer. This had a height corresponding to about 50% of the clearance height of the reactor interior. The helical stirrer had a design such that it allowed temperature measurement directly in the bed. The autoclave was charged with 10.0 g of the porous carbon (spec. surface area=2010 m²/g, Gurvich pore volume=0.95 cm³/g) and sealed. The autoclave was initially evacuated. It was subsequently pressurized to a pressure of 15.1 bar with DCS (1 g) and SiH₄ (15 g). The autoclave was then heated to a temperature of 420° C. within 90 minutes and the temperature was maintained for 210 minutes. The pressure increased to 74 bar over the course of the reaction. The autoclave cooled to room temperature (20° C.) within 12 hours. An autoclave pressure of 33.5 bar remained after cooling. The pressure in the autoclave was reduced to 1 bar before purging three times with nitrogen. An amount of 20.8 g of silicon-carbon composite particles in the form of a black, fine solid were isolated under an Ar atmosphere. After exchanging the Ar atmosphere for air the product was suspended in water (30 ml/1 g product), treated for 1 h in an ultrasonic bath at 80° C. and filtered off in a Büchner funnel while measuring pH. The whole procedure was repeated until the pH of the washing water was >3.

The reaction conditions for production and the material properties of the silicon-carbon composite particles are summarized in the following table 2.

TABLE 1

| | | | BET | | | | | | |
|---|---|---|---|---|---|---|---|---|---|
| | | temper- | surface | | | | | | |
| | | ature | area | Si content | CI content | O content. | H content. | N content | |
| | CVI precursor | [° C.] | [m²/g] | [% by wt.] | [% by wt.] | [% by wt.] | [% by wt.] | [% by wt.] | pH |
| Comparative | Monosilane | 430 | 39 | 52 | 0 | 2.6 | 0.80 | 0.64 | 5.9 |
| Example 1A* | | | | | | | | | |
| Comparative | Trichlorsilane | 450 | 122 | 42.0 | 8.0 | 13.5 | 0.47 | 0.83 | 1.6 |
| Example 1B* | | | | | | | | | |
| Example 1 | Trichlorsilane | 450 | 156 | 42.4 | 7.7 | 12.1 | 0.92 | 0.43 | 3.1 |
| Example 2 | Dichlorsilane | 415 | 29 | 45.2 | 3.9 | 1.6 | 0.75 | 0.97 | 3.9 |
| Example 3 | Trichlorsilane + | 380.380 | 27 | 50.0 | 0.68 | 15.6 | 1.22 | 0.95 | 4.5 |
| | Monosilane | | | | | | | | |
| Example 4 | Dichlorsilane + | 380.400 | 14.5 | 48 | 1.1 | 17.0 | 1.08 | 0.64 | 3.5 |
| | Monosilan | | | | | | | | |
| Example 5 | Dichlorsilane + | 420 | 45 | 57 | 0.2 | 3.4 | 0.85 | 1.21 | 4.5 |
| | Monosilane | | | | | | | | |
| | mixed (parallel) | | | | | | | | |

*noninventive

Identical material characteristics are obtainable irrespective of the employed silicon precursors.

### Evaluation of the Silicon-Carbon Composite Particles in Electrochemical Cells

Comparative example 7: Anode containing noninventive silicon-carbon composite particles from comparative example 1A and electrochemical testing in a lithium-ion battery.

29.71 g of polyacrylic acid (dried to constant weight at 85° C.; Sigma-Aldrich, Mw˜450 000 g/mol) and 756.60 g of deionized water were agitated using a shaker (290 rpm) for 2.5 h until complete dissolution of the polyacrylic acid. Lithium hydroxide monohydrate (Sigma-Aldrich) was added to the solution a little at a time until the pH was 7.0 (measured using WTW pH 340i PH meter and SenTix RJD probe). The solution was then mixed by shaker for a further 4 h. 3.87 g of the neutralized polyacrylic acid solution and 0.96 g of graphite (Imerys, KS6L C) were initially charged in a 50 ml vessel and blended at 2000 rpm in a planetary mixer (SpeedMixer, DAC 150 SP). Subsequently 3.40 g of the silicon-carbon composite particles according to the invention from example 1A were stirred at 2000 rpm for 1 min. 1.21 g of an 8 percent conductive carbon black dispersion and 0.8 g of deionized water were then added and incorporated at 2000 rpm using the planetary mixer. This was followed by dispersion using the dissolver for 30 min at 3000 rpm at a constant 20° C. Degassing of the ink was again carried out using the planetary mixer at 2500 rpm for 5 minutes under vacuum.

The finished dispersion was then applied to a copper foil having a thickness of 0.03 mm (Schlenk Metallfolien, SE-Cu58) using a film-drawing frame with a gap clearance of 0.1 mm (Erichsen, model 360). The anode coating thus produced was then dried at 60° C. and 1 bar of air pressure for 60 min. The average basis weight of the dry anode coating was 2.2 mg/cm² and the coating density 0.9 g/cm³.

The electrochemical studies were carried out using a button cell (CR2032 type, Hohsen Corp.) in a 2-electrode arrangement. The electrode coating was used as counterelectrode or negative electrode (Dm=15 mm); a coating based on lithium-nickel-manganese-cobalt oxide 6:2:2 having a content of 94.0% and average basis weight of 15.9 mg/cm² (obtained from SEI) was used as the working electrode or positive electrode (Dm=15 mm). A glass fiber filter paper (Pall, GF type A/E) soaked with 60 μl of electrolyte was used as the separator (Dm=16 mm). The employed electrolyte was composed of a 1.0 molar solution of lithium hexafluorophosphate in a 1:4 (v/v) mixture of fluoroethylene carbonate and diethyl carbonate. The construction of the cell was carried out in a glovebox (<1 ppm H₂O, O₂) and the water content in the dry matter of all employed components was below 20 ppm.

Electrochemical testing was carried out at 22° C. The cell was charged by the cc/cv method (constant current/constant voltage) with a constant current of 15 mA/g (corresponding to C/10) in the first cycle and of 75 mA/g (corresponding to C/2) in the subsequent cycles and, on attainment of the voltage limit of 4.2 V, at constant voltage until a current fell below 1.5 mA/g (corresponding to C/100) or 3 mA/g (corresponding to C/50). The cell was discharged by the cc method (constant current) with a constant current of 15 mA/g (corresponding to C/10) in the first cycle and of 75 mA/g (corresponding to C/2) in the subsequent cycles until attainment of the voltage limit of 2.5 V. The specific current chosen was based on the weight of the coating of the positive electrode. The electrodes were selected in such a way that a capacitance ratio of cathode: anode=1:1.2 was established.

Comparative example 8: Anode containing noninventive silicon-carbon composite particles from comparative example 1B and electrochemical testing in a lithium-ion battery.

The noninventive silicon-containing material from comparative example 1B was used to produce an anode as described in comparative example 7. The anode was installed in a lithium-ion battery as described in comparative example 7 and subjected to testing by the same procedure.

Comparative example 9: Anode containing noninventive silicon-carbon composite particles from comparative example 1C and electrochemical testing in a lithium-ion battery.

Noninventive silicon-carbon composite particles from comparative example 1C were used to produce an anode as described in comparative example 7. The anode was installed in a lithium-ion battery as described in comparative example 7 and subjected to testing by the same procedure.

Example 10: Anode Containing Silicon-Carbon Composite Particles From Example 3 and Electrochemical Testing in a Lithium-Ion Battery

The silicon-containing material according to the invention from example 3 was used to produce an anode as described in comparative example 7. The anode was installed in a lithium-ion battery as described in comparative example 7 and subjected to testing by the same procedure.

The results from the electrochemical evaluations are summarized in table 3 which follows.

Example 11: Anode Containing Silicon-Carbon Composite Particles From Example 1 and Electrochemical Testing in a Lithium-Ion Battery

The silicon-containing material according to the invention from example 1 was used to produce an anode as described in comparative example 7. The anode was installed in a lithium-ion battery as described in comparative example 7 and subjected to testing by the same procedure.

The results from the electrochemical evaluations are summarized in table 3 which follows.

TABLE 2

| | Rev. capacity in second | Cycle with 80% |
|---|---|---|
| | cycle [mAh/g] | capacity retention |
| Comparative | 916 | 346 |
| example 7* | | |
| Comparative | 365 | 125 |
| example 8* | | |
| Example 10 | 892 | 419 |
| Example 11 | 648 | 217 |
| (from Ex. 1) | | |

*noninventive

The comparison between comparative example 7 and example 10 according to the invention reveals that the presence of a chlorine content in the material does not show any adverse effects on the electrochemical performance. The comparison between comparative example 8 and example 11 according to the invention reveals that an excessively low pH has an adverse effect on the electrochemical performance in the battery, whereas adapting the pH stabilizes the performance.

1-14. (canceled)

15. Silicon subhalide-containing composite particles, comprising:
a Si content >30% by weight;
wherein the silicon is placed in and on the pores of a porous matrix;
a halogen concentration of 0.0003 to 16% by weight;
a pH of 3 to 9;
a volume-weighted particle size distribution having diameter percentiles d₅₀ of 0.5 to 20 μm; and
a specific BET surface area of at most 170 m²/g.

16. The composite particles of claim 15, wherein the halogen is chlorine and a Cl concentration of 0.0003 to 16% by weight.

17. The composite particles of claim 15, wherein the silicon is at least partially present in a form of silicon subchloride SiClₓ, wherein x=0.00001-0.15.

18. The composite particles of claim 15, wherein the silicon subhalide-containing composite particles comprise at least 30% by weight of silicon obtained by silicon infiltration.

19. The composite particles of claim 15, wherein the composite particles are an anode material for a lithium-ion battery.

20. The composite particles of claim 19, wherein a current collector is coated with the anode material.

21. A process for producing the composite particles, comprising:
silicon infiltration from silicon precursors selected from halogen-containing and halogen-free silicon precursors that are gaseous and/or liquid at 20° C. and 1013 mbar, wherein at least one halogen-containing silicon precursor is present, in the presence of porous particles having,
(a) a volume-weighted particle size distribution having diameter percentiles d₅₀ of 0.5 to 20 μm ,
(b) a total pore volume (Gurvich pore volume) of micropores and mesopores determined by N₂ sorption in the range 0.4-2.2 cm³/g, and
(c) a PD50 pore diameter determined by N₂ sorption of not more than 30 nm.

22. The process of claim 21, wherein the composite particles are silicon subhalide-containing composite particles.

23. The process of claim 22, wherein silicon subhalide-containing composite particles have a Si content >30% by weight;
wherein the silicon is placed in and on the pores of a porous matrix;
a halogen concentration of 0.0003 to 16% by weight;
a pH of 3 to 9;
a volume-weighted particle size distribution having diameter percentiles d₅₀ of 0.5 to 20 μm; and
a specific BET surface area of at most 170 m²/g.

24. The process of claim 21, wherein the silicon infiltration is carried out in a reactor selected from fluidized bed reactors, rotary kilns arranged in a horizontal to vertical position, open or closed fixed-bed reactors and pressure reactors.

25. The process of claim 21, wherein silicon infiltration is performed at 280° C. to 900° C.

26. The process of claim 21, wherein the composite particles are produced by silicon infiltration from silanes selected from monosilane and chlorine-containing silanes, wherein at least one chlorine-containing silane is employed.

27. The process of claim 21, wherein reactive components free from silicon are also present in admixture or alternately with the silicon precursors.

28. A lithium-ion battery, comprising:
at least one anode containing silicon subhalide-containing composite particles; and
wherein the silicon subhalide-containing composite particles comprise a Si content >30% by weight,
wherein the silicon is placed in and on the pores of a porous matrix,
a halogen concentration of 0.0003 to 16% by weight,
a pH of 3 to 9,
a volume-weighted particle size distribution having diameter percentiles d₅₀ of 0.5 to 20 μm , and
a specific BET surface area of at most 170 m²/g.

29. The lithium-ion battery of claim 28, wherein the halogen is chlorine and a Cl concentration of 0.0003 to 16% by weight.

30. The lithium-ion battery of claim 28, wherein the silicon is at least partially present in a form of silicon subchloride SiClₓ, wherein x=0.00001-0.15.

31. The lithium-ion battery of claim 28, wherein the silicon subhalide-containing composite particles comprise at least 30% by weight of silicon obtained by silicon infiltration.
